(19) United States
(12) Patent Application Publication
(10) Pub. No.: US 2008/0112088 A1
(43) Pub. Date: May 15, 2008

(54) Perpendicular magnetic write head having a wrap around trailing shield with a flux return path

(75) Inventors: Wen-Chien David Hsiao, San Jose, CA (US); Yimin Hsu, Sunnyvale, CA (US); Edward Hin Pong Lee, San Jose, CA (US); Vladimir Nikitin, Campbell, CA (US); Aron Pentek, San Jose, CA (US); Yi Zheng, San Ramon, CA (US)

Correspondence Address: ZILKA-KOTAB, PC- HIT, P.O. BOX 721120, SAN JOSE, CA, 95172-1120, US

(73) Assignee: HITACHI GLOBAL STORAGE TECHNOLOGIES

(21) Appl. No.: 11/598,417

(22) Filed: Nov. 13, 2006

(51) Int. Cl. G11B 5/33

(52) U.S. Cl. 360/319

(57) ABSTRACT

A magnetic write head for perpendicular magnetic recording that has write pole, a return pole and a trailing shield that is magnetically connected with magnetic return pole. The write head includes a magnetic pedestal and first and second magnetic studs that connect the trailing shield with the pedestal. The studs are laterally spaced a distance that is not greater than 5 um from the nearest side of the write pole. In other words, the studs are spaced from each other a distance that is no greater than the width of the leading edge of the write pole plus 10 um. This spacing of the studs prevents saturation of the trailing shield, maximizing field gradient and ensuring optimal magnetic write performance.

### FIELD OF THE INVENTION

The present invention relates to perpendicular magnetic recording and more particularly to a method for manufacturing a write head for perpendicular magnetic recording that has a trailing shield that avoids magnetic saturation by being efficiently magnetically connected with a magnetic return pole.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head has traditionally included a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic transitions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor includes a nonmagnetic conductive layer, referred to as a spacer layer, sandwiched between first and second ferromagnetic layers, referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to meet the ever increasing demand for improved data rate and data capacity, researchers have recently been focusing their efforts on the development of perpendicular recording systems. A traditional longitudinal recording system, such as one that incorporates the write head described above, stores data as magnetic bits oriented longitudinally along a track in the plane of the surface of the magnetic disk. This longitudinal data bit is recorded by a fringing field that forms between the pair of magnetic poles separated by a write gap.

A perpendicular recording system, by contrast, records data as magnetizations oriented perpendicular to the plane of the magnetic disk. The magnetic disk has a magnetically soft underlayer covered by a thin magnetically hard top layer. The perpendicular write head has a write pole with a very small cross section and a return pole having a much larger cross section. A strong, highly concentrated magnetic field emits from the write pole in a direction perpendicular to the magnetic disk surface, magnetizing the magnetically hard top layer. The resulting magnetic flux then travels through the soft underlayer, returning to the return pole where it is sufficiently spread out and weak that it will not erase the signal recorded by the write pole when it passes back through the magnetically hard top layer on its way back to the return pole.

One feature of perpendicular recording systems is that the low coercivity underlayer of the magnetic medium is particularly susceptible to stray magnetic fields. Unintended magnetic fields, such as from structures of the write head other than the write pole and even coming from the sides of the write pole itself can inadvertently write to portions of the medium that are outside of the intended trackwidth.

Another feature of perpendicular magnetic systems is that the magnetism of the high coercivity magnetic medium can be difficult to quickly switch. It is desired that the system have a high field gradient at transitions so that the magnetic state of the medium can be quickly switched from one direction to another.

Therefore, there is a need for a magnetic write head for perpendicular recording that can effectively avoid stray magnetic fields from inadvertently writing to the magnetic medium. There is also a need for a write head structure that can increase magnetic field gradient, allowing fast switching of the magnetic medium from one magnetic state to another.

### SUMMARY OF THE INVENTION

The present invention provides magnetic write head for perpendicular magnetic recording. The write head has a magnetic write pole, a magnetic return pole and a trailing shield. A magnetic pedestal extends from the return pole to toward, but not to the write pole, and first and second magnetic studs connect the trailing shield with the pedestal. The studs are formed at either side of the write pole, although they may be completely beneath (leading) the write pole, and are each separated from the write pole by a lateral distance that is not greater than 5 um. In other words, the studs are separated from one another by a distance of not greater than the width of the leading edge of the write pole plus 10 um.

The magnetic studs may be separated from the write pole by a distance that is 4-5 um, and therefore, may be separated from on anther by a distance that is equal to the width of the leading edge of the write pole plus 8-10 um.

The studs and pedestal magnetically connect the trailing shield with the pedestal in order to keep conduct flux from the trailing shield. Ensuring that the studs maintain this desired maximum spacing from the write pole ensures that the trailing shield will not become saturated, and improves write field gradient and writing performance.

The trailing shield can be either a wrap around shield which has side portions that wrap around the sides of the write pole, or can be a purely trailing shield having a leading edge that does not extend down beyond (in the leading direction) the trailing edge of the write pole.

Because the trailing shield is magnetically connected with the return pole, the trailing shield functions as a second return pole as well as a trailing shield, allowing the write head to function as a cusp head design, enjoying the advantages of a cusp head design without many of the disadvantaged. The write head, therefore, can be considered to have a leading return pole and a trailing return pole (trailing shield) both of which are connected with one another by magnetic structures located entirely at the ABS. Both the leading and trailing return poles are driven by a single magnetomotive force in the form of the write coil disposed between the trailing return pole and the write pole. A write head according to an embodiment of the invention, therefore, provides the efficiency benefits of a cusp head design such as increased flux return path, while avoiding the manufacturing complexity ordinarily associated with such designs.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view, taken from line 3-3 of FIG. 2 and rotated 90 degrees counterclockwise, of a magnetic head according to an embodiment of the present invention;

FIG. 4 is an ABS view of the write head taken from line 4-4 of FIG. 3;

FIG. 5 is an enlarged ABS view of a portion of the head shown in FIG. 4;

FIG. 6 is an ABS view of a write head according to an alternate embodiment of the invention; and

FIG. 7 is an enlarged ABS view of a portion of the head shown in FIG. 7.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

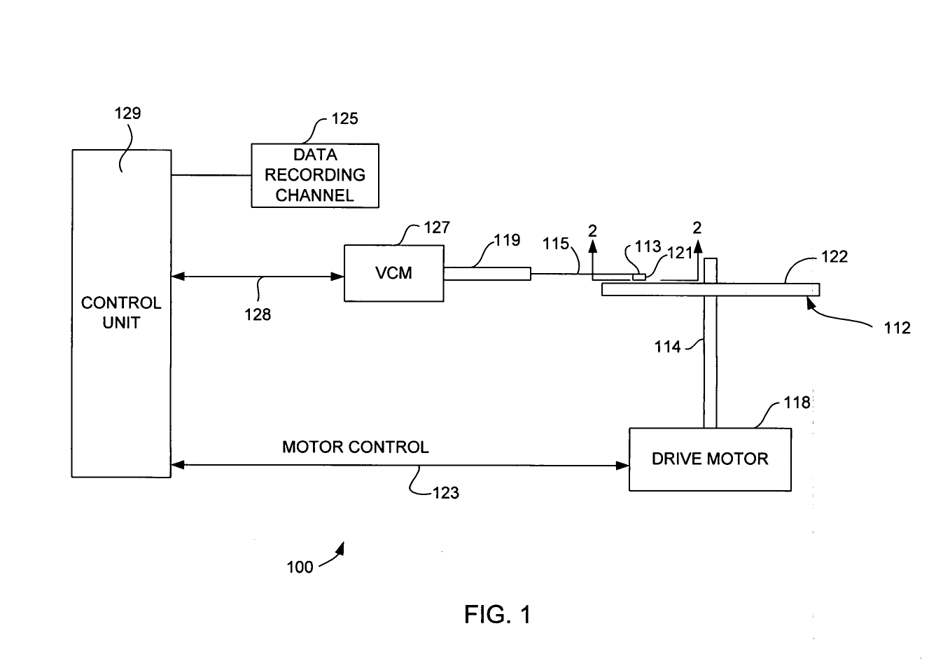

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 221. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

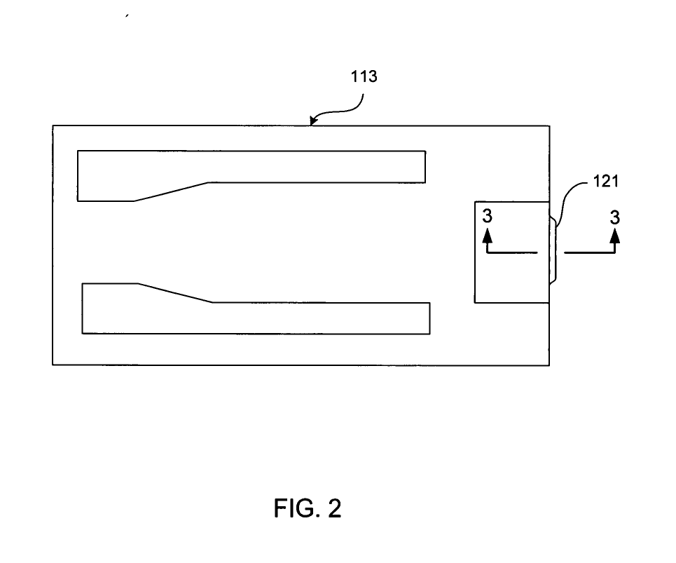

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

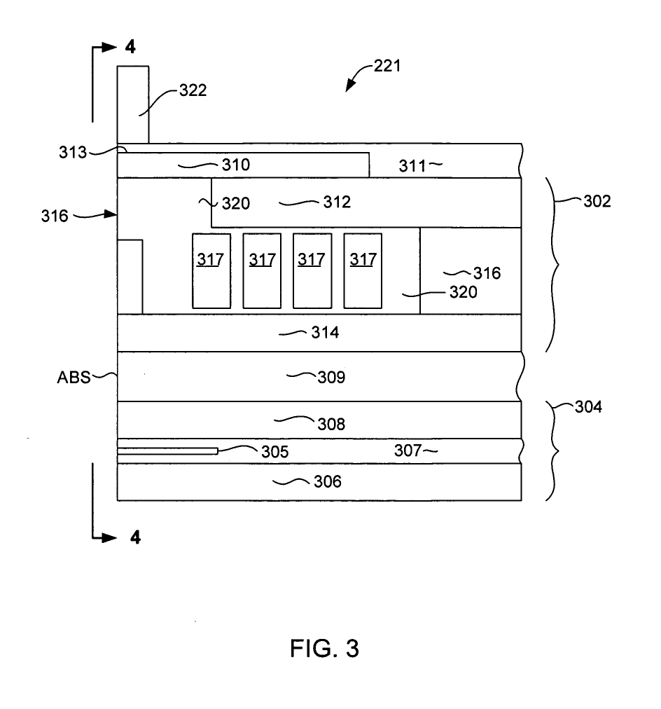

With reference now to FIG. 3, the magnetic head 221 for use in a perpendicular magnetic recording system is described. The head 221 includes a write element 302 and a read element 304. The read element includes a magnetoresistive sensor 305, such as a current in plane giant magnetoresistive (CPP GMR) sensor. However, the sensor 305 could be another type of sensor such as a current perpendicular to plane (CPP) GMR sensor or, a tunnel junction sensor (TMR) or some other type of sensor. The sensor 305 is located between and insulated from first and second magnetic shields 306, 308 and embedded in a dielectric material 307. The magnetic shields 306, 308, which can be constructed of for example CoFe or NiFe, absorb magnetic fields such as those from up-track or down track data signals, ensuring that the read sensor 304 only detects the desired data track located between the shields 306, 308. A non-magnetic, electrically insulating gap layer 309 may be provided between the shield 308 and the write head 302.

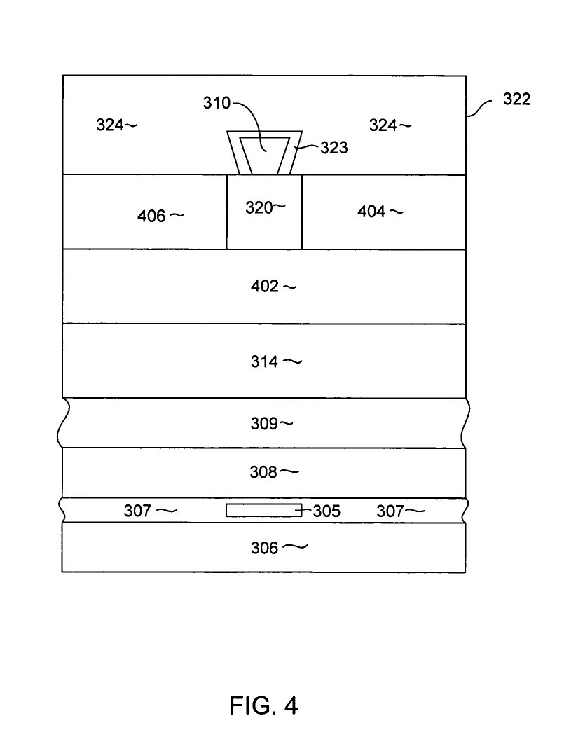

With continued reference to FIG. 3, the write element 302 includes a write pole 310 that is magnetically connected with a magnetic shaping layer 312, and is embedded within an insulation material 311. The write pole 310 has a pole tip portion 313 disposed toward the ABS. The write pole 310 has a small cross section at the air bearing surface (as seen in FIG. 4) and is constructed of a material having a high saturation moment, such as NiFe or CoFe. More preferably, the write pole 310 is constructed as a lamination of layers of magnetic material separated by thin layers of non-magnetic material. The write element 302 also has a return pole 314 that preferably has a surface exposed at the ABS and has a cross section parallel with the ABS surface that is much larger than that of the write pole 310. The return pole 314 is magnetically connected with the shaping layer 312 by a back gap portion 316. The shaping layer 312, return pole 314 and back gap 316 can be constructed of, for example, NiFe, CoFe or some other magnetic material.

An electrically conductive write coil 317, shown in cross section in FIG. 3, passes through the write element 302 between the shaping layer 312, and the return pole 314, and wraps around the back gap structure 316. The write coil 317 is surrounded by an electrically insulating material 320 that electrically insulates the turns of the coil 317 from one another and electrically isolates the coil 317 from the surrounding magnetic structures 310, 312, 316, 314. When a current passes through the coil 317, the resulting magnetic field causes a magnetic flux to flow through the return pole 314, back gap 316, shaping layer 312 and write pole 310. This magnetic flux causes a write field to be emitted toward an adjacent magnetic medium (not shown in FIGS. 3 and 4). The insulation layers 320 can be constructed of a material such as alumina (Al₂0₃) or can be constructed as various layers of the same or different electrically insulating, non-magnetic materials.

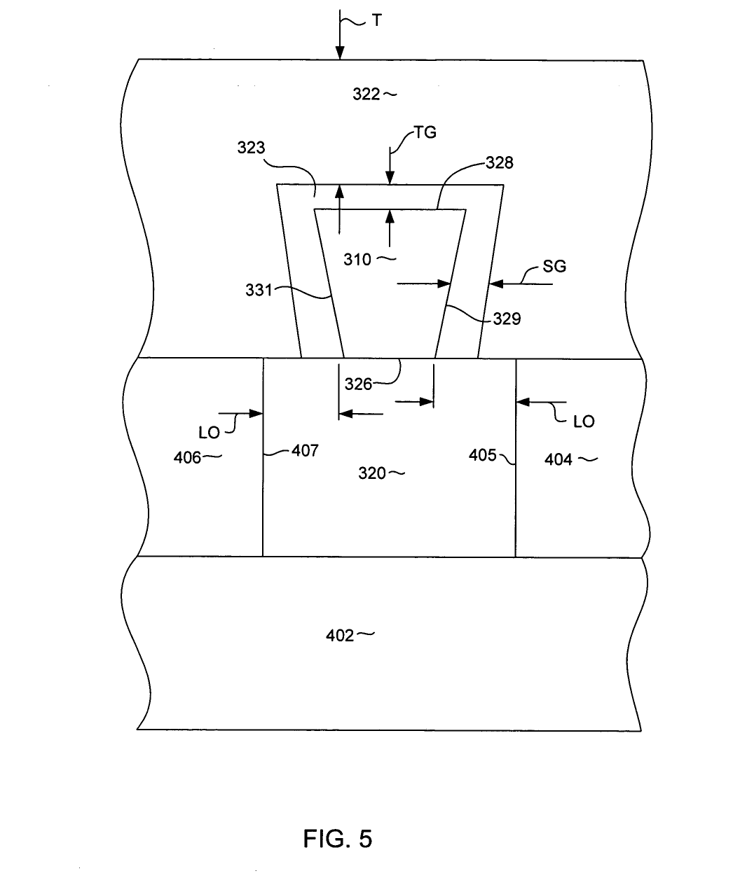

FIGS. 4 and 5 are views as seen from the ABS. FIG. 5 is an enlarged view of a portion of the structure shown in FIG. 4. As seen in FIGS. 4 and 5, the write pole 310 has a leading edge 326 and a trailing edge 328. The terms leading and trialing refer to the direction of travel over the magnetic medium when the write head 221 is un use. First and second laterally opposed sides 329, 331 each extend from the leading edge 326 to the trailing edge 328. The write pole 310 preferably has a trapezoidal shape as viewed from the ABS. This trapezoidal shape, wherein the write pole 310 is narrower at the leading edge 326 than at the trailing edge 328 prevents skew related adjacent track interference when the write head is located at inner and outer portions of magnetic disk (FIG. 1).

With reference to FIGS. 4 and 5, the write head element 302 may also include a trailing shield 322, which can be constructed of a magnetic material such as NiFe or some other material. The trailing shield 322 can be configured with side portions 324 that wrap around the write pole 310 to provide side shielding as well as trailing shielding from stray magnetic fields. These stray magnetic fields can be from the write head 302 itself or could also be from adjacent track signals or from magnetic fields from external sources. Therefore, the side portions 324 can each have a leading edge 330 that preferably extends at least to the leading edge 326 of the write pole 310.

As can be seen, the trailing shield 322 is separated from the shield 322 by a non-magnetic shield gap material 323 such as alumina or some other material or combination of materials. The trailing portion of the shield 322 is separated from the trailing edge 328 of the write pole 310 by trailing gap thickness (TG), and is separated from the laterally opposed sides of the write pole by a side gap thickness (SG). The portion of the trailing shield 322 that is adjacent to the trailing edge 328 of the write pole 310 increases the field gradient of the write head. This is accomplished by drawing the write field toward this trailing portion of the trailing shield 322, which cants the write field a desired amount. Therefore, the write field is not perfectly perpendicular, but is canted somewhat in the trailing direction.

The trailing gap thickness TG involves a tradeoff. If the trailing gap TG is to large, field gradient will not be large enough. If the trailing shield gap TG is too small, and unacceptable amount of write field will be lost to the trailing shield, resulting in a weak write field. Therefore, the thickness of the trailing gap TG should be somewhat tightly controlled. The thickness of the side gaps SG is, however, not as critical. The side gaps SG are preferably larger than the trailing gap TG.

A magnetic pedestal 402 extends upward (in the trailing direction) from the return pole 314 toward, but not to, the write pole 310. As can be seen in FIG. 3, the pedestal 402 extends from the air bearing surface (ABS) to a location short of the coil 317. This distance from the ABS is the pedestal throat height. A pedestal throat height that is too large will shunt too much magnetic flux from the write pole, thereby reducing write field. A throat height that is to small is difficult to control during manufacture. The pedestal 402 preferably has a throat height of 0.5 to 1.5 um. Referring again to FIG. 4, a pair of magnetic connection studs 404, 406 extend from the pedestal 402 to the trailing, wrap-around shield 322. In this way, the pedestal 402 and connection studs 404, 406 magnetically connect the shield 322 to the return pole 314. The space between the studs 404, 406 and between the write pole 310 and the pedestal 402 is filled with the non-magnetic, electrically insulating fill material 320.

With reference to FIG. 5, each of the connection studs has an inner edge that is laterally offset from the sides of the write pole by a lateral offset distance (LO). It has been found that improved magnetic performance can be realized by maintaining a desired amount of lateral offset LO between the connection studs 404, 406 and the lateral sides of the write pole 310. More specifically, maximum performance is achieved by maintaining a lateral offset LO of less than or equal to 5 um. The lateral offset is also preferably less than about 6 times the trailing shield thickness T as measured in the down track direction (ie. measured from trailing edge the write pole) in the region where the trailing shield trails the write pole. In other words, the studs 404, 406 each have inner edges 405, 407 that are separated from one another by a distance that is not greater than the width of the leading edge 326 of pole tip portion of the write pole 310 plus 10 um. Optimal performance can be achieved by maintaining a lateral offset of 4-5 um. If the lateral offset LO of the connection studs 404, 406 is too small (ie. approaching contact with the write head 310) magnetic flux will be lost to the studs 404, 406, and the write field will diminish. On the other hand if the lateral offset LO is too great, then the shield 322 can become magnetically saturated in the presence of a stray magnetic field, and thus lose its efficacy.

A magnetic write head having connection studs 404, 406 with the above described desired lateral offset LO have been found to provide a 10 percent improvement in field gradient. In addition, such a structure reduces magnetic saturation of the soft underlayer of the magnetic media as well as reducing magnetic saturation of the trailing shield 322 as well as reducing magnetic saturation of the shield 322 when a stray field is present. Reducing the magnetically soft underlayer (SUL) saturation allows further reduction in SUL thickness in the magnetic medium (not shown), which would reduce the cost of manufacturing the magnetic medium by reducing SUL deposition time. The disk medium uniformity can also be improved when deposited on top of the thinner SUL. In general, the design trend is toward having a proper perpendicular writer combined with thinner SUL medium, when it is possible. The robustness against the external stray field makes the disk drive more reliable when there is an unexpected external field present, thereby avoiding potential write errors.

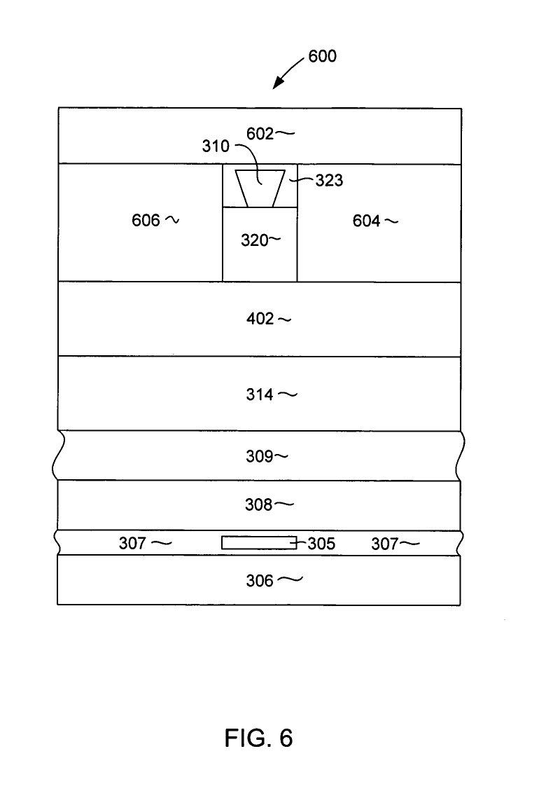

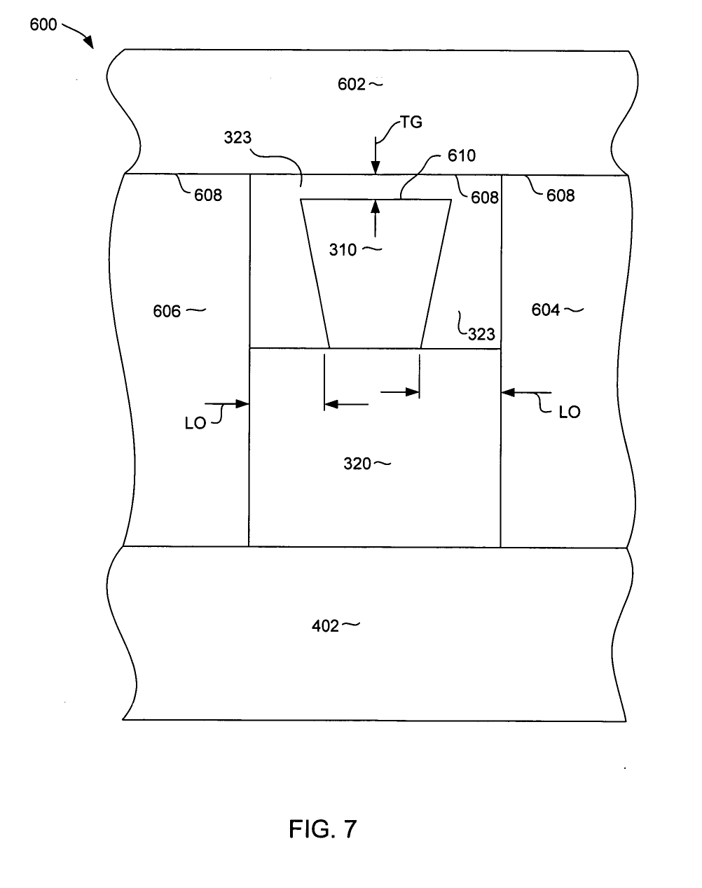

With reference now to FIGS. 6 and 7, the invention can also be embodied in a head 600 having a trailing shield 602 that is purely a trailing shield and does not wrap around the sides of the write pole 310. In other words, such a trailing shield has a leading edge 608 that does not extend beyond (in the leading direction) the trailing edge 610 of the write pole 310. This head 600 has first and second magnetic studs 604, 606 that extend from the trailing shield 602 (beyond the trailing edge 610 of the write pole 310) all of the way to the pedestal 402. Another way to characterize this structure is that it has a trailing shield 602 and has side shielding portions (studs 604, 606) that extend from the trailing shield to the pedestal 402. As with the previously described embodiment, the studs 604, 606 have a lateral offset LO that is less than or equal to 5 um, and which is preferably 4-5 um.

The above described write head structures 302 and 600 can also be described as a cusp head, because they provide the writing efficiency advantages of a cusp head design but with much greater simplicity and ease of manufacture. A cusp head design is a perpendicular write head design that has magnetic return poles both up-track from the write pole (leading) and down track from the write pole (trailing). The leading and trailing return poles in such designs can be magnetically connected at a back gap structure. In addition to being difficult to manufacture, such designs include the risk that excessive write field will be lost to the relatively large second return pole.

The present design provides the efficiency advantages of such a cusp design without the above described disadvantages. For purposes of illustration, these cusp-design features will be described with reference to FIGS. 3, 4 and 5. As can be seen, the trailing shield 322 is magnetically connected with the return pole 402. This means that a magneto-motive force such as that from the write coil 317, which motivates magnetic flux to flow from the write pole 310 to the return pole (through the magnetic media, not shown here) also motivates magnetic flux to flow through from the write pole 310 to the shield 322. This provides significant performance advantages. For example, part of this flux flow from the write pole 310 to the trailing shield 322 can be through the media. Therefore, the trailing shield acts as a second return pole rather than just as a trailing shield. This allows the write head to write with increased write field without running the risk of saturating the magnetically hard top layer of the media (ie. without the return pole writing to the media), because the effective area of the return path for the magnetic flux is greatly increased by the presence of the shield 322.

In addition, since the trailing shield 322 is magnetically connected with the return pole 402, the magnetomotive force from the coil 317 also increases the efficiency with which the trailing shield 322 can increase the write field gradient. Maintaining the above described lateral offset distances LO described above, maximizes the efficiency with which the trailing shield effectuates these cusp design advantages. In addition, because the trailing shield is magnetically connected with the return pole 402 only in an area near the ABS, there is much less risk of robbing flux from the write pole than would be the case if a return pole were included that ran alongside the write pole 310 and shaping layer 312 all of the way from the ABS to the back-gap 316. In addition, whereas previous cusp head designs have required multiple coils to drive flux through both of the return poles, the above described design can use a single coil 317 to drive flux through both the return pole 402 and the trailing shield 322.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic write head for perpendicular magnetic recording, comprising:
a magnetic write pole having a pole tip portion disposed toward an air bearing surface (ABS), the pole tip portion having first and second laterally opposed sides, a leading edge and a trailing edge;
a magnetic return pole having an end disposed toward the ABS, the return pole being magnetically connected with the write pole in a region away from the ABS;
a magnetic pedestal, magnetically connected with the magnetic return pole at the end disposed toward the ABS, the pedestal extending from the return pole toward, but not to, the write pole;
a magnetic trailing shield having an edge that is separated from the trailing edge of the write pole by a non-magnetic gap material, the trailing shield extending laterally beyond the first and second laterally opposed sides of the pole tip portion of the write pole; and
a magnetic stud, magnetically connected with both the trailing shield and the pedestal, the magnetic stud being separated from the write pole by a lateral distance not greater than 5 um.

2. A magnetic write head for perpendicular magnetic recording, comprising:
a magnetic write pole having a pole tip portion disposed toward an air bearing surface (ABS), the pole tip portion having a leading edge, a trailing edge and a side extending from the leading edge to the trailing;
a magnetic return pole having an end disposed toward the ABS, the return pole being magnetically connected with the write pole in a region away from the ABS;
a magnetic pedestal, magnetically connected with the magnetic return pole at the end disposed toward the ABS, the pedestal extending from the return pole toward, but not to, the write pole;
a magnetic trailing shield having an edge that is separated from the trailing edge of the write pole by a non-magnetic gap material, the trailing shield extending laterally beyond the side of the pole tip portion of the write pole; and
a magnetic stud, magnetically connected with both the trailing shield and the pedestal, the magnetic stud having an inner edge that is laterally offset from the side of the pole tip portion of the write pole by a distance of 4-5 um.

3. A magnetic write head for perpendicular magnetic recording comprising:
a magnetic write head having an end terminating at an air bearing surface (ABS), the end of the write pole having a leading edge, a trailing edge and first and second laterally opposed sides that are separated by a distance that defines a track width (TW);
A magnetic return pole having an end terminating at the ABS;
a magnetic trailing shield separated from the trailing edge of the write pole by a non-magnetic gap material, the trailing shield extending laterally beyond the first and second sides of the write pole;
first and second magnetic studs, each being magnetically magnetically connected with the return pole and with the trailing shield, the first and second magnetic studs being separated from one another by a distance that is not greater than the track width plus 10 um.

4. A write head as in claim 3 further comprising a magnetic pedestal connected with the return pole at the end terminating at the ABS and connected with each of the first and second studs.

5. A magnetic write head for perpendicular magnetic recording comprising:
a magnetic write head having an end terminating at an air bearing surface (ABS), the end of the write pole having a leading edge, a trailing edge and first and second laterally opposed sides that are separated by a distance that defines a track width (TW);
A magnetic return pole having an end terminating at the ABS;
a magnetic trailing shield separated from the trailing edge of the write pole by a non-magnetic gap material, the trailing shield extending laterally beyond the first and second sides of the write pole;
first and second magnetic studs, each being magnetically magnetically connected with the return pole and with the trailing shield, the first and second magnetic studs being separated from one another by a distance that is equal to the track-width plus 8-10 um.

6. A magnetic head as in claim 3 wherein the trailing shield does not wrap around the sides of the write pole.

7. A magnetic head as in claim 3 wherein the trailing shield has a trailing portion adjacent to the trailing edge of the write pole and separated from the trailing edge of the write pole by a non-magnetic trailing gap, and wherein the trailing shield has first and second side portions that wrap around the sides of the write pole the first and second side portions of the trailing shield being separated from the sides of the write pole by first and second non-magnetic side gap layers.

8. A magnetic write head as in claim 3 wherein the write pole and the return pole are magnetically connected with one another at a region removed from the ABS.

9. A magnetic write head as in claim 3 further comprising:
a magnetic shaping layer that is recessed from the ABS and is magnetically connected with the write pole; and
a magnetic back gap layer that is magnetically connected with the return pole and with the shaping layer in a region removed from the ABS.

10. A magnetic write head as in claim 9 further comprising an electrically conductive write coil that wraps around the back gap.

11. A magnetic write head for perpendicular magnetic recording, comprising:
a magnetic write head having a pole tip portion disposed toward an air bearing surface (ABS) the pole tip portion terminating in an end exposed at the ABS, the end of the pole it portion of the write pole being configured with a trapezoidal shape having a leading edge, a trailing edge and first and second sides each extending from the trailing edge to the leading edge, the distance between the first and second sides being larger at the trailing edge than at the leading edge;
a magnetic return pole, magnetically connected with the write pole in a region away from the ABS;
a trailing magnetic shield having a trailing portion separated from the trailing edge of the write pole by a non-magnetic trailing gap material, and having first and second side portions that wrap around the pole tip portion of the write pole, the side portions each being separated from the first and second sides of the write pole by a non-magnetic side gap material; and wherein
first and second magnetic studs each magnetically connected with the trailing shield and with the return pole and each being magnetically isolated from the write pole; and wherein:
the first side of the write pole meets the leading edge of the write pole at a junction that defines a first lateral location;
the first magnetic stud has an inner edge facing the second magnetic stud, the inner edge of the first magnetic stud defining a second lateral location; and
the distance between the first and second lateral locations is not greater than 5 um.

12. A write head as in claim 11, wherein:
the second side of the write pole meets the leading edge of the write pole at a second junction that defines a third lateral location;
the second magnetic stud has an inner edge facing the first magnetic stud, the inner edge of the second stud defining a fourth lateral location; and
the distance between the forth and fifth lateral locations being no greater than 5 um.

13. A magnetic write head for perpendicular magnetic recording, comprising:
a magnetic write head having a pole tip portion disposed toward an air bearing surface (ABS) the pole tip portion terminating in an end exposed at the ABS, the end of the pole tip portion of the write pole being configured with a trapezoidal shape having a leading edge, a trailing edge and first and second sides each extending from the trailing edge to the leading edge, the distance between the first and second sides being larger at the trailing edge than at the leading edge;
a magnetic return pole, magnetically connected with the write pole in a region away from the ABS;
a magnetic pedestal formed at the ABS, contacting the return pole, and extending toward, but not to, the write pole;
a trailing magnetic shield having a trailing portion separated from the trailing edge of the write pole by a non-magnetic trailing gap material, and having first and second side portions that wrap around the pole tip portion of the write pole, the side portions each being separated from the first and second sides of the write pole by a non-magnetic side gap material; and
first and second magnetic studs each magnetically connected with the trailing shield and the magnetic pedestal and each magnetically isolated from the write pole; and wherein:
the first side of the write pole meets the leading edge of the write pole at a junction that defines a first lateral location;
the first magnetic stud has an inner edge facing the second magnetic stud, the inner edge of the first magnetic stud defining a second lateral location; and
the distance between the first and second lateral locations is not greater than 5 um.

14. A write head as in claim 13, wherein:
the second side of the write pole meets the leading edge of the write pole at a second junction that defines a third lateral location;
the second magnetic stud has an inner edge facing the first magnetic stud, the inner edge of the second stud defining a fourth lateral location; and
the distance between the forth and fifth lateral locations being no greater than 5 um.

15. A magnetic head as in claim 13 further comprising a magnetic shaping layer that is recessed from the ABS and that is magnetically connected with the write pole, and a magnetic back gap portion that is magnetically connected with the return pole and the shaping layer in a region removed from the ABS.

16. A magnetic head as in claim 15 further comprising an electrically conductive write coil that passes between the shaping layer and the return pole and which wraps around the back gap.

17. A magnetic write head for perpendicular magnetic recording, comprising:
a magnetic write head having a pole tip portion disposed toward an air bearing surface (ABS) the pole tip portion terminating in an end exposed at the ABS, the end of the pole tip portion of the write pole being configured with a trapezoidal shape having a leading edge, a trailing edge and first and second sides each extending from the trailing edge to the leading edge, the distance between the first and second sides being larger at the trailing edge than at the leading edge;
a magnetic return pole, magnetically connected with the write pole in a region away from the ABS;
a magnetic pedestal formed at the ABS, contacting the return pole, and extending toward, but not to, the write pole;
a trailing magnetic shield having a trailing portion separated from the trailing edge of the write pole by a non-magnetic trailing gap material, and having first and second side portions that wrap around the pole tip portion of the write pole, the side portions each being separated from the first and second sides of the write pole by a non-magnetic side gap material; and
first and second magnetic studs each magnetically connected with the trailing shield and the magnetic pedestal and each magnetically isolated from the write pole; and wherein:
the distance between the first and second sides where they meet the leading edge of the write pole define a leading edge pole width; and
the first and second studs are separated from one another by a distance that is no greater than the leading edge pole width plus 10 um.

18. A magnetic head as in claim 17 wherein the first and second magnetic studs are separated from one another by a distance that is equal to the leading edge pole width plus 8-10 um.

19. A magnetic head as in claim 17, further comprising:
a magnetic shaping layer that is connected with the write pole; and
a magnetic back gap structure that is connected with the shaping layer and the return pole.

20. A magnetic head as in claim 19 further comprising an electrically conductive write coil that wraps around the back gap structure.

21. A magnetic write head for perpendicular magnetic recording, comprising:
a magnetic write pole having a pole tip portion disposed toward an air bearing surface (ABS), the pole tip portion having first and second laterally opposed sides, a leading edge disposed at an up-track direction on the write pole and a trailing edge disposed in a down track direction on the write pole;
a magnetic return pole having an end disposed toward the ABS, the return pole being magnetically connected with the write pole in a region away from the ABS;
a magnetic pedestal, magnetically connected with the magnetic return pole at the end disposed toward the ABS, the pedestal extending from the return pole toward, but not to, the write pole;
a magnetic trailing shield having an edge that is separated from the trailing edge of the write pole by a non-magnetic gap material, the trailing shield extending laterally beyond the first and second laterally opposed sides of the pole tip portion of the write pole, the trailing shield having a thickness T measured in the down track direction at a location trailing the write pole; and
a magnetic stud, magnetically connected with both the trailing shield and the pedestal, the magnetic stud being separated from the write pole by a lateral distance not greater than 6 times the shield thickness T.

22. A magnetic write head for perpendicular magnetic recording, comprising:
a write pole, constructed of a magnetic material, having an end disposed toward an Air Bearing Surface (ABS) and having a leading edge, a trailing edge and first and second laterally opposed sides each extending from the leading edge to the trailing edge;
a leading return pole, constructed of a magnetic material, the leading return pole being magnetically connected with the write pole in a region away from the ABS;
an electrically conductive write coil disposed between the write pole and leading return pole, the write coil being magnetically and electrically isolated from the write pole and leading return pole.
a trailing return pole disposed at the ABS, the trailing return pole being separated from the trailing edge of the write pole by a non-magnetic trailing gap so that the trailing return pole functions as a trailing shield;
a magnetic stud, disposed at the ABS, the magnetic stud being magnetically connected with both the trailing return pole and the leading return pole the magnetic stud having an inner edge that is offset from one of the first and second sides of the write pole by a distance not greater than 5 um.

23. A magnetic write head for perpendicular magnetic recording, comprising:
a write pole, constructed of a magnetic material, having an end disposed toward an Air Bearing Surface (ABS) and having a leading edge, a trailing edge and first and second laterally opposed sides each extending from the leading edge to the trailing edge;
a leading return pole, constructed of a magnetic material, the leading return pole being magnetically connected with the write pole in a region away from the ABS;
an electrically conductive write coil disposed between the write pole and leading return pole, the write coil being magnetically and electrically isolated from the write pole and leading return pole.
a trailing return pole disposed at the ABS, the trailing return pole being separated from the trailing edge of the write pole by a non-magnetic trailing gap so that the trailing return pole functions as a trailing shield;
a magnetic stud, disposed at the ABS, the magnetic stud being magnetically connected with both the trailing return pole and the leading return pole the magnetic stud having an inner edge that is offset from one of the first and second sides of the write pole by a distance of 4-5 um.

24. A magnetic write head for perpendicular magnetic recording, comprising:
a write pole, constructed of a magnetic material, having an end disposed toward an Air Bearing Surface (ABS) and having a leading edge, a trailing edge and first and second laterally opposed sides each extending from the leading edge to the trailing edge, the first and second sides being separated from one another at the leading edge by a distance (TW);
a leading return pole, constructed of a magnetic material, the leading return pole being magnetically connected with the write pole in a region away from the ABS;
an electrically conductive write coil disposed between the write pole and the leading return pole, the write coil being magnetically and electrically isolated from the write pole and leading return pole.
a trailing return pole disposed at the ABS, the trailing return pole being separated from the trailing edge of the write pole by a non-magnetic trailing gap so that the trailing return pole functions as a trailing shield;
first and second magnetic studs, disposed at the ABS, the magnetic studs being magnetically connected with both the trailing return pole and the leading return pole the magnetic studs being separated from one another by a distance not greater than the distance TW plus 10 um.

25. A magnetic write head for perpendicular magnetic recording, comprising:
a write pole, constructed of a magnetic material, having an end disposed toward an Air Bearing Surface (ABS) and having a leading edge, a trailing edge and first and second laterally opposed sides each extending from the leading edge to the trailing edge, the first and second sides being separated from one another at the leading edge by a distance (TW);
a leading return pole, constructed of a magnetic material, the leading return pole being magnetically connected with the write pole in a region away from the ABS;
an electrically conductive write coil disposed between write pole and the leading return pole, the write coil being magnetically and electrically isolated from the write pole and leading return pole.
a trailing return pole disposed at the ABS, the trailing return pole being separated from the trailing edge of the write pole by a non-magnetic trailing gap so that the trailing return pole functions as a trailing shield;
first and second magnetic studs, disposed at the ABS, the magnetic studs being magnetically connected with both the trailing return pole and the leading return pole the magnetic studs being separated from one another by a distance of TW plus 8-10 um.
